(19) United States
(12) Patent Application Publication
(10) Pub. No.: US 2013/0016338 A1
(43) Pub. Date: Jan. 17, 2013

(54) SCANNER WITH PHASE AND PITCH ADJUSTMENT

(71) Applicants: Robert E. Bridges, Kennett Square, PA (US); Ryan Kruse, Waltham, MA (US); Yu Gong, Orlando, FL (US); Paul McCormack, Carlisle, MA (US); Emmanuel Lafond, Tewksbury, MA (US)

(72) Inventors: Robert E. Bridges, Kennett Square, PA (US); Ryan Kruse, Waltham, MA (US); Yu Gong, Orlando, FL (US); Paul McCormack, Carlisle, MA (US); Emmanuel Lafond, Tewksbury, MA (US)

(73) Assignee: FARO TECHNOLOGIES, INC., Lake Mary, FL (US)

(21) Appl. No.: 13/540,737

(22) Filed: Jul. 3, 2012

Related U.S. Application Data
(60) Provisional application No. 61/507,763, filed on Jul. 14, 2011.

(51) Int. Cl. G01B 11/14; G01B 9/02

(52) U.S. Cl. 356/51; 356/498; 356/482

(57) ABSTRACT

A method for determining three-dimensional coordinates of an object point on a surface of an object, including steps of providing a transparent plate having a first region and a second region, the second region having a different wedge angle than the first region; splitting a first beam of light into a first light and a second light; sending the first light through the first region or the second region; combining the first light and the second light to produce a fringe pattern on the surface of the object, the pitch of the fringe pattern depending on the wedge angle through which the first light travels; imaging the object point onto an array point on a photosensitive array to obtain an electrical data value; determining the three-dimensional coordinates of the first object point based at least in part on the electrical data value.

### CROSS-REFERENCE TO RELATED APPLICATIONS

The present application claims the benefit of U.S. Provisional Patent Application No. 61/507,763, filed on Jul. 14, 2011, the contents of which are hereby incorporated by reference in their entirety.

### BACKGROUND

The present disclosure relates to a coordinate measuring device. One set of coordinate measurement devices belongs to a class of instruments that measure the three-dimensional (3D) coordinates of a point by projecting a pattern of light to an object and recording the pattern with a camera.

A particular type of coordinate measuring device, sometimes referred to as an accordion fringe interferometer, forms the projected pattern of light by the interference of light of diverging wavefronts emitted by two small, closely spaced spots of light. The resulting fringe pattern projected onto the object is analyzed to find 3D coordinates of surface points for each separate pixel within the camera.

In one implementation of an accordion fringe interferometer, a diffraction grating, a capacitive feedback sensor, a flexure stage, multiple laser sources, and multiple objective lenses are included. This type of accordion fringe interferometer is relatively expensive to manufacture and relatively slow in performing measurements. What is needed is an improved method of finding 3D coordinates.

### SUMMARY OF THE INVENTION

According to one embodiment of the present invention, a method for determining three-dimensional coordinates of a first object point on a surface of an object includes the steps of: providing a first transparent plate having a first transparent region and a second transparent region, the first region having a first surface, a second surface, a first index of refraction, and a first wedge angle, the first wedge angle being an angle between the first surface and the second surface, the second region having a third surface, a fourth surface, a second index of refraction, and a second wedge angle, the second wedge angle being an angle between the third surface and the fourth surface; splitting a first beam of light into a first light and a second light, the first light and the second light being mutually coherent. The method also includes: sending, in a first case, the first light through the first region, the first light passing through the first surface and the second surface, the first region configured to change a direction of the first light by a first deflection angle, the first deflection angle responsive to the first wedge angle and the first index of refraction; sending, in a second case, the first light through the second region, the first light passing through the third surface and the fourth surface, the second region configured to change a direction of the first light by a second deflection angle, the second deflection angle responsive to the second wedge angle and the second index of refraction, wherein the second deflection angle is different than the first deflection angle. The method further includes: combining, in the first case, the first light and the second light to produce a first fringe pattern on the surface of the object, the first fringe pattern having a first pitch at the first object point, the first pitch responsive to the first deflection angle; combining, in the second case, the first light and the second light to produce a second fringe pattern on the surface of the object, the second fringe pattern having a second pitch at the first object point, the second pitch responsive to the second deflection angle, the second pitch different than the first pitch; imaging, in the first case, the first object point onto a first array point on a photosensitive array to obtain a first electrical data value from the photosensitive array; imaging, in the second case, the first object point onto the first array point on the photosensitive array to obtain a second electrical data value from the photosensitive array; determining the three-dimensional coordinates of the first object point based at least in part on the first electrical data value and the second electrical data value; and storing the three-dimensional coordinates of the first object point.

According to another embodiment of the present invention, a method for determining three-dimensional coordinates of a first object point on a surface of an object includes the steps of: splitting a first beam of light into a first light and a second light, the first light and the second light being mutually coherent; providing a first transparent plate assembly including a transparent plate and a rotation mechanism, the first transparent plate having a first surface, a second surface, a first index of refraction, a first thickness, the first surface and the second surface being substantially parallel, the first thickness being a distance between the first surface and the second surface, the rotation mechanism configured to rotate the first transparent plate. The method also includes: rotating, in a first instance, the first transparent plate to obtain a first angle of incidence of the first surface with respect to the first light; rotating, in a second instance, the first transparent plate to obtain a second angle of incidence of the first surface with respect to the first light, the second angle of incidence not equal to the first angle of incidence; rotating, in a third instance, the first transparent plate to obtain a third angle of incidence of the first surface with respect to the first light, the third angle of incidence not equal to the first angle of incidence or the second angle of incidence. The method further includes: combining the first light and the second light to produce, in the first instance, a first fringe pattern on the surface of the object; combining the first light and the second light to produce, in the second instance, a second fringe pattern on the surface of the object; combining the first light and the second light to produce, in the third instance, a third fringe pattern on the surface of the object; imaging, in the first instance, the first object point onto a first array point on a photosensitive array to obtain a first electrical value from the photosensitive array; imaging, in the second instance, the first object point onto the first array point to obtain a second electrical value from the photosensitive array; imaging, in the third instance, the first object point onto the first array point to obtain a third electrical value from the photosensitive array; determining the three-dimensional coordinates of the first object point based at least in part on the first electrical data value, the second electrical data value, the third electrical data value, the first thickness, the first index of refraction, the first angle of incidence, the second angle of incidence, and the third angle of incidence; and storing the three-dimensional coordinates of the first object point.

According to yet another embodiment of the present invention, a method for determining three-dimensional coordinates of a first object point on a surface of an object includes the steps of: splitting a first beam of light into a first light and a second light, the first light and the second light being mutually coherent; providing a first transparent plate assembly including a transparent plate and a rotation mechanism, the first transparent plate having a first surface, a second surface, a first index of refraction, a first thickness, the first surface and the second surface being substantially parallel, the first thickness being a distance between the first surface and the second surface, the rotation mechanism configured to rotate the first transparent plate. The method also includes: rotating, in a first instance, the first transparent plate to obtain a first angle of incidence of the first surface with respect to the first light; rotating, in a second instance, the first transparent plate to obtain a second angle of incidence of the first surface with respect to the first light, the second angle of incidence not equal to the first angle of incidence; rotating, in a third instance, the first transparent plate to obtain a third angle of incidence of the first surface with respect to the first light, the third angle of incidence not equal to the first angle of incidence or the second angle of incidence; combining the first light and the second light to produce, in the first instance, a first fringe pattern on the surface of the object. The method further includes: combining the first light and the second light to produce, in the second instance, a second fringe pattern on the surface of the object; combining the first light and the second light to produce, in the third instance, a third fringe pattern on the surface of the object; imaging, in the first instance, the first object point onto a first array point on a photosensitive array to obtain a first electrical value from the photosensitive array; imaging, in the second instance, the first object point onto the first array point to obtain a second electrical value from the photosensitive array; imaging, in the third instance, the first object point onto the first array point to obtain a third electrical value from the photosensitive array; determining the three-dimensional coordinates of the first object point based at least in part on the first electrical data value, the second electrical data value, the third electrical data value, the first thickness, the first index of refraction, the first angle of incidence, the second angle of incidence, and the third angle of incidence; and storing the three-dimensional coordinates of the first object point.

### BRIEF DESCRIPTION OF THE DRAWINGS

Referring now to the drawings, exemplary embodiments are shown which should not be construed to be limiting regarding the entire scope of the disclosure, and wherein the elements are numbered alike in several FIGURES:

FIG. 1 is a schematic diagram illustrating the triangulation principle of operation of a 3D measuring device;

FIG. 2 is a block diagram showing elements of an exemplary projector in accordance with an embodiment of the present invention;

FIG. 3 is a schematic diagram showing the main elements of an exemplary projector in accordance with an embodiment of the present invention;

FIG. 4, which includes FIGS. 4A and 4B, is a schematic diagram that illustrates an effect associated with sending two collimated beams of light into a lens;

FIG. 5 is a plot of the interference patterns observed on a workpiece for two different ways of sending light into an objective lens in an exemplary projector;

FIG. 6 is a schematic diagram comparing the geometry of light rays passing through tilted and untilted windows;

FIG. 7 is a schematic diagram illustrating the geometry of light rays passing through a pair of tilted windows;

FIGS. 8A and 8B are drawings showing top views of a phase adjuster mechanism at different rotation angles in accordance with an embodiment of the present invention;

FIGS. 9A and 9B are drawings showing a side view and a top view, respectively, of a phase adjuster mechanism in accordance with an embodiment of the present invention;

FIGS. 10A and 10B are drawings showing a front view and a cross sectional view, respectively, of a phase adjuster plate in accordance with an embodiment of the present invention;

FIG. 11 is a drawing that shows the geometry of a ray of light passing through a tilted and wedged window;

FIG. 12 is a drawing showing the geometry of rays of light passing through an assembly that includes three wedged windows in accordance with an embodiment of the present invention;

FIGS. 13A and 13B are a top view and side view of a fringe pitch adjuster assembly;

FIGS. 14A-4D are drawings that show front, first sectional, second sectional, and top views, respectively, of a phase and fringe adjuster window in accordance with an embodiment of the present invention;

FIGS. 15A and 15B are front and top views, respectively, of an assembly capable of adjusting phase and fringe pitch in accordance with an embodiment of the present invention;

FIG. 16 is a schematic drawing showing elements of a motorized stage that applies linear motion to a phase/fringe adjuster in accordance with an embodiment of the present invention;

FIG. 17 is a schematic drawing showing a mirror rotated by a motor to an angle measured by an angular encoder in accordance with an embodiment of the present invention;

FIG. 18A is a block diagram showing a phase shifter in accordance with an embodiment of the present invention;

FIG. 18B is a block diagram showing a spatial light modulator for shifting phase and fringe pitch in accordance with an embodiment of the present invention;

FIG. 19 is a block diagram a mirror adjusted by a piezoelectric stage in accordance with an embodiment of the present invention;

FIG. 20, which includes FIGS. 20A-D, is a schematic diagram showing a method of setting the angle of a mirror by pushing the mirror to fixed stops with an actuator in accordance with an embodiment of the present invention; and

FIG. 21 is a schematic diagram showing elements of an alternative interferometer arrangement in accordance with an embodiment of the present invention.

### DETAILED DESCRIPTION

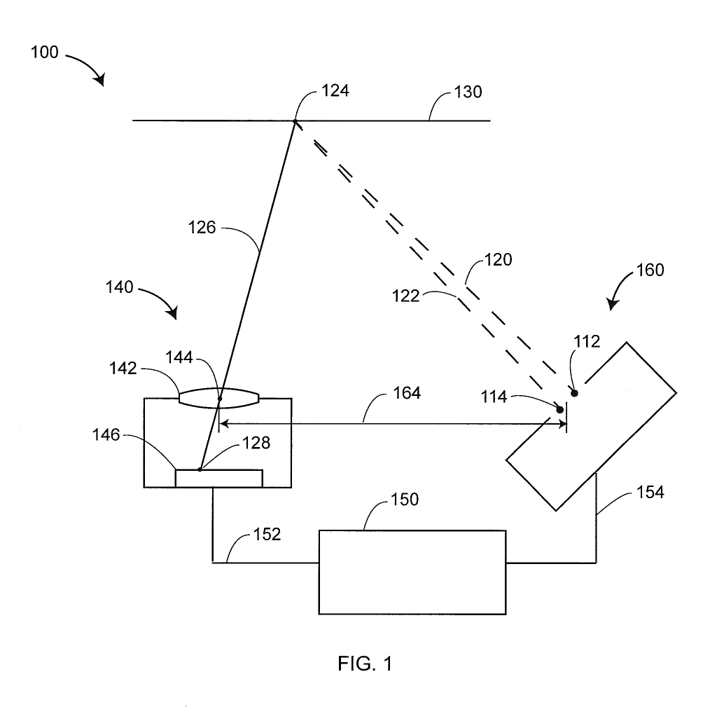

An exemplary 3D measuring device 100 that operates according to the principle of accordion fringe interferometry is shown in FIG. 1. A projector 160 under control of an electronics unit 150 produces two small spots of light 112, 114. These spots of light produce a pattern of fringes on the surface of a workpiece 130. The irradiance of the pattern at a particular point 124 is determined by the interference of the two rays of light 120, 122 at the point 124. At various points on the surface of the workpiece 130, the light rays 120, 122 interfere constructively or destructively, thereby producing the fringe pattern. A camera 140 includes a lens system 142 and a photosensitive array 146. The camera 140 forms an image on photosensitive array 146 of the pattern of light on the workpiece 130. The light from the point 124 may be considered to pass through a center of symmetry 144 of a lens system 142 to form an image point 128 on the photosensitive array. A particular pixel of the photosensitive array 146 receives light scattered from a small region of the surface of the workpiece 130. The two angles that define the direction from this small region through the perspective center 144 to the particular pixel are known from the geometrical properties of the camera 140, including the lens system 142.

The light falling onto the photosensitive array 146 is converted into digital electrical signals, which are sent to electronics unit 150 for processing. The electronics unit 150, which includes a processor, calculates the distance from the perspective center 144 to each point on the surface of the workpiece 130. This calculation is based at least in part on a known distance 164 from the camera 140 to the projector 160. For each pixel in the camera 140, two angles and a calculated distance are known, as explained herein above. By combining the information obtained from all the pixels, a three dimensional map of the workpiece surface is obtained.

The method of calculating distances using accordion fringe interferometry according to the system 100 shown in FIG. 1 is to shift the relative phase of the two spots 112, 114, which has the effect of moving the fringes on the workpiece. Each pixel of the camera measures the level of light obtained from equal exposures for each of the three phase shifts, the three phase shifts are obtained by changing the relative phases of the spots 112, 114. For each pixel, at least three measured light levels are used by the processor within the electronics unit 150 to calculate the distance to a region on the workpiece surface 130.

If the distance from the scanner to the workpiece can change by a relatively large amount, the scanner will also need the ability to resolve ambiguities in the measured distance. In this case, because the spacing between the fringes is relatively small, there are several possible valid distance solutions based on the images collected by the camera. This ambiguity can be removed by changing the spacing (pitch) between fringes by a known amount and then repeating the phase shift measurement. In an embodiment, three different fringe pitches are used. To calculate 3D coordinates, the system 100 in most cases needs at least two fringe pitch values.

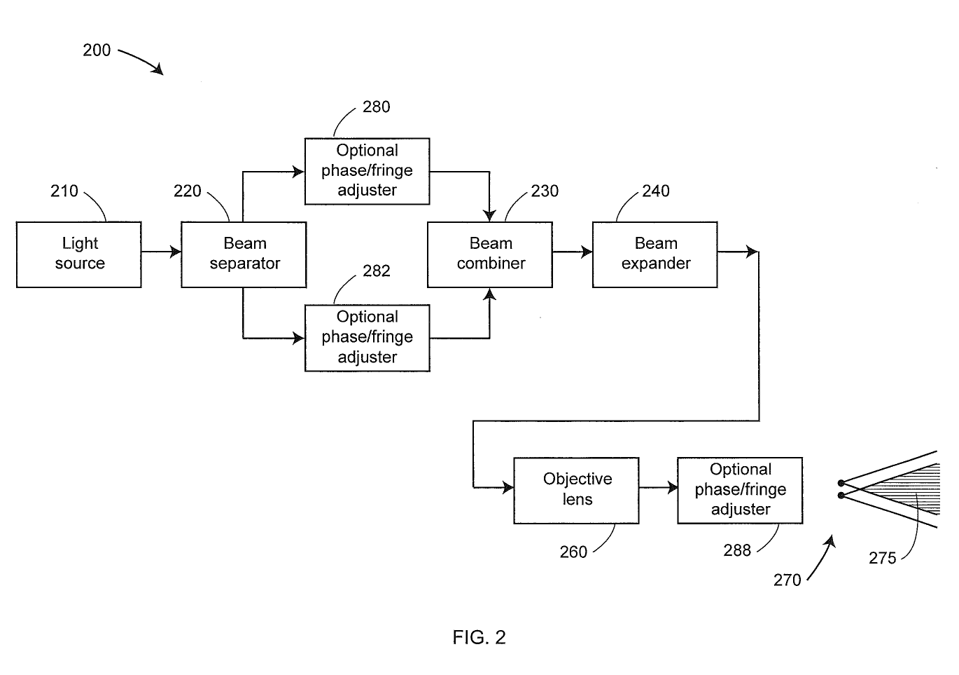

FIG. 2 shows the elements of an exemplary projector 200 according to an embodiment. A light source 210 sends light to a beam separator 220. The light splits into two parts, one part that may pass through an optional phase/fringe adjuster 280 and the other part that may pass through an optional phase/fringe adjuster 282. The two beams of light are combined in a beam combiner 230. The light passes through a beam expander 240, an objective lens 260, and an optional phase/fringe adjuster 288. Two spots of light 270, the spots which may be real or virtual, are formed by the objective lens 260. For example, real spots may be formed if the objective lens 260 is a positive lens and virtual spots may be formed if the objective lens 260 is a negative lens. Interference occurs in the overlap region 275 and may be seen at a point on a workpiece surface.

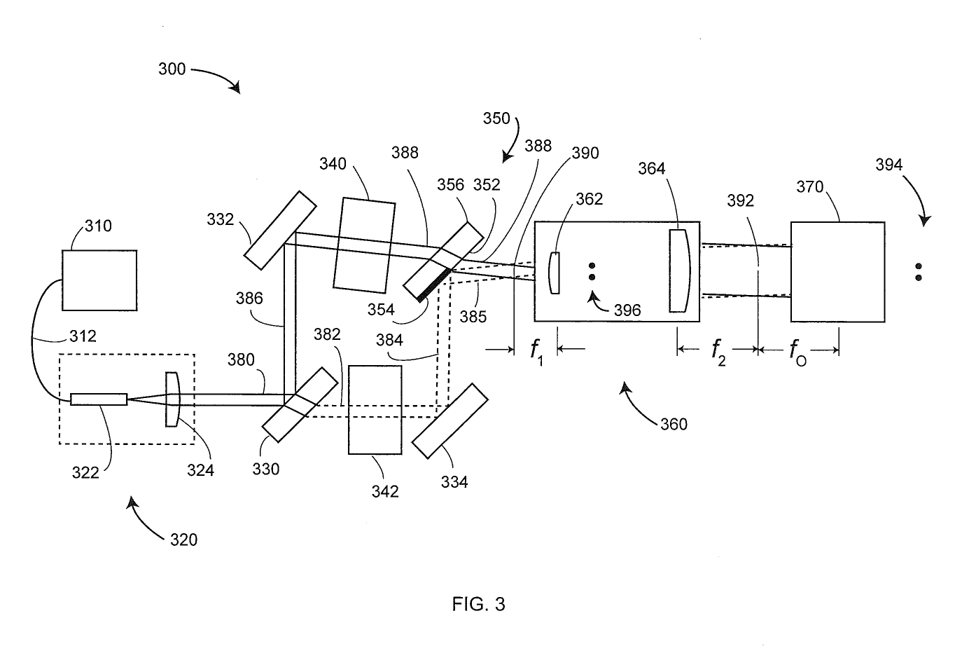

FIG. 3 shows specific elements of an exemplary projector 300 that correspond to the generic elements of FIG. 2. Light source 310 provides light that might come from a laser, a superluminescent diode, LED or other source. In an embodiment, the light from the light source 310 travels through an optical fiber 312 to a fiber launch 320 that includes a ferrule 322 and a lens 324. Alternatively, light from light source 310 may travel through free space to reach lens 324. Collimated light 380 leaving the fiber launch 320 travels to beam splitter 330 which splits the light into a transmitted part 382 and a reflected part 386. In an embodiment, the coating of the first surface of the beam splitter 330 reflects 50% and transmits 50% of the light, and the coating of the second surface of the beam splitter 330 is an anti-reflection coating.

The light 386 reflects off mirror 332, travels through optional phase/fringe adjuster 340, and passes through a first region of a beam combiner 356, the first region having an antireflection coating 352. The light 382 passes through optional phase/fringe adjuster 342, reflects off mirror 334, and reflects off a second region 354 of beam combiner 356, the second region having a reflective coating. The two beams of light 385, 389 that emerge from beam combiner 356 intersect at position 390. An afocal beam expander 360, which in an embodiment includes two positive lens elements 362, 364, is positioned so that the focal length of the first lens element 362 is placed a distance equal to the focal length f₁ of the first lens element 362 away from the intersection point 390. The two collimated beams of light 385, 389 are focused by the first lens element 362 to two spots of light at a distance f₁ from the first lens 362. The distance between the lenses 362 and 364 is equal to f₁+f₂ so that the two spots within the beam expander are a distance f₂ from the second lens element 364. Two collimated beams of light 391, 393 emerge from the beam expander 360. The size of the emerging beams 391, 393 equals the transverse magnification M of the beam expander times the size of the incident beams, where the magnification is M=f₂/f₁. The angle between the two emerging laser beams is reduced by a factor of 1/M compared to the angle between the incident laser beams 391, 393. As an example, suppose that the diameter of each incident laser beam 385, 389 is 0.7 mm with the beams having a separation angle of 120 milliradians (mrad). Also suppose that the transverse magnification of the beam expander 360 is M=10. The emerging laser beams 391, 393 then each have a diameter of 7 mm and an angle of separation of 12 mrad. The collimated beams of light 391, 393 emerging from the beam expander 360 intersect at position 392. The objective lens 370, which might be a 40× microscope objective having a focal length of f_{O}=4.5 mm and a numerical aperture of NA=0.65, for example, is placed so that the distance from the front focal position of the objective lens 370 from the intersection point 392 is equal to the focal length f_{O} of the objective lens 370. The objective lens 370 focuses the collimated beams 391, 393 into two small spots 394.

For a high quality objective lens 370 having the characteristics mentioned above, the beam overfills the entrance aperture, so that a reasonable approximation for the diameter of the focused spot diameter for light having a wavelength of 658 nm is d₀=1.22×/NA=1.22 (0.658×10⁻³)/0.65 mm=1.24 micrometers. Each of the beams diverges to a far-field half angle of a value somewhat greater than θ_{1/2}=4λ²/πd₀²=0.27 radian. If, for example, the distance from the 3D measuring device to the workpiece to L=0.75 meter, the area covered by the diverging beams of light is somewhat larger than w=2L tan(θ_{1/2})=0.4 meter. Suppose that three different fringe spacings (pitches) are desired and that these spacings can be achieved by setting the distances αᵢ (i=1, 2, 3) between the two small spots 394 to three different values: 46 micrometers, 52 micrometers, and 58 micrometers. In this case, the angles of separation between the collimated beams 391, 393 are given by γᵢ=aᵢ/f_{O}=110.2, 11.6, 12.91 mrad for the three desired spot spacings. For the three spot spacings, the spacings h, between the fringes on a workpiece located a distance r from the projection points 394 are hᵢ=aᵢλ/r. For the distance r=L, the three fringe spacings are hᵢ=aᵢλ/L={10.7, 9.5, 8.5} mm.

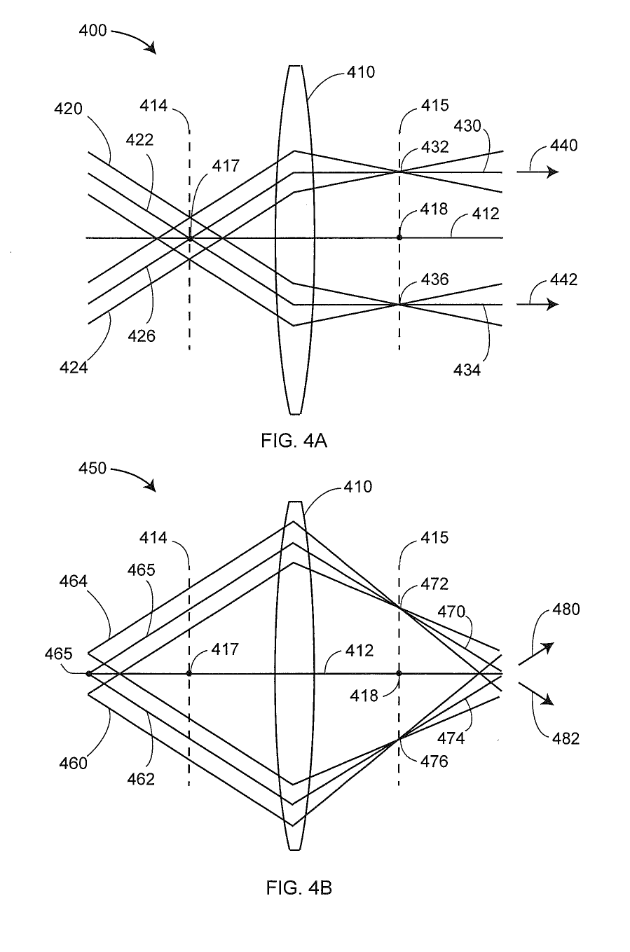

FIG. 4A shows two collimated beams of light 420, 424 entering a lens 410 at an angle with respect to the optical axis 412 and passing through the front focal point 417 of the lens 410. In this case, the central ray 422 of the beam 420 emerges as a ray 434 parallel to the optical axis 412. The rays of beam 420 are focused to a small spot 436 at the back focal plane, which is a plane that passes through the back focal point 418 and is perpendicular to the optical axis 412. The central ray 426 of the beam 424 emerges as a ray 430 parallel to the optical axis 412. The rays of beam 424 are focused to a small spot 432 at the back focal plane. For an angle of separation γ between the beams 420 and 424 and for a lens having a focal length f_{O}, the distance between the small spots 436 and 432 is a=γf_{O}. For the situation shown in FIG. 4A, the beams of light diverge from the points 432, 436 to the right of the drawing, and for the two beams the central rays 430, 434, which represent the directions of the centers of projected energy for the beams, are parallel to the optical axis. In an embodiment the spacing a between the spots 432, 436 is a small value on the order of 50 micrometers. The light emerging from the spots 432, 436 diverge and at the workpiece may have expanded to more than 0.4 meter. To ensure maximum overlap of the beams of light, the central rays 430 and 434 should emerge in the directions 440, 442 parallel to the optical axis.

FIG. 4B shows two collimated beams of light 460, 464 that do not pass through the front focal point of the lens 410. The central ray 462 of the beam 460 emerges from the lens 410 in a direction not parallel to the optical axis 412. The rays of the beam 460 are focused to a small spot 476 in the back focal plane of the lens 410, but the energy 480 is sent along a direction 480, which is not parallel to the optical axis. The central ray 465 of the beam 464 emerges from the lens 410 in a direction not parallel to the optical axis 412. The rays of beam 464 are focused to a small spot 472 in the back focal plane of the lens 410, but the energy is sent along a direction 482, which is not parallel to the optical axis.

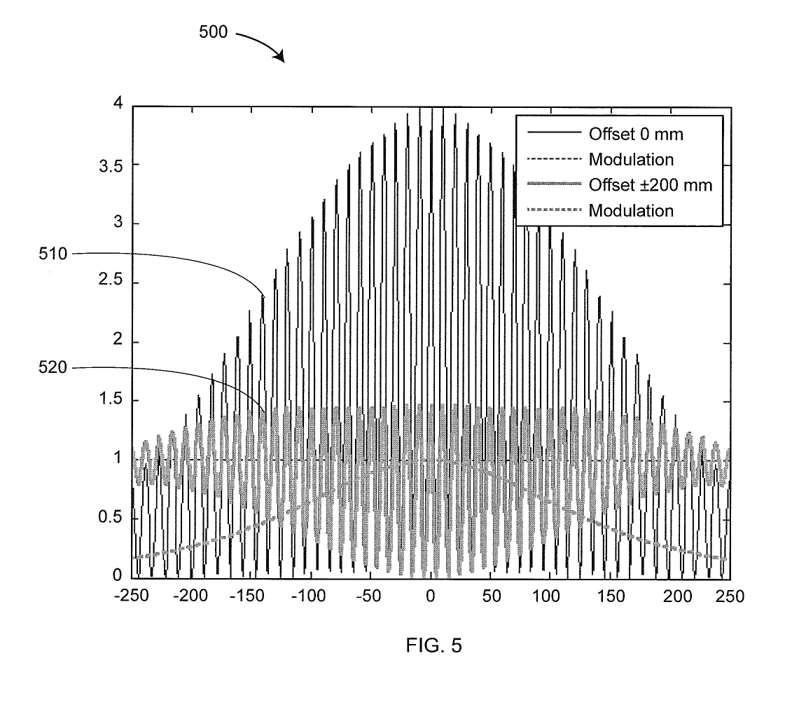

FIG. 5 compares fringe irradiances for two cases depicted in FIGS. 4A and 4B. On the graph 500, the plotted values indicate a relative irradiance of fringes on a workpiece, the workpiece distance extending in this case from −250 mm to +250 mm. Plotted values 510 represent relative fringe irradiances obtained when the centers of energy from the two spots 394 travel parallel to the optical axis so that the beams achieve maximum overlap. Plotted values 520 represent relative fringe irradiances obtained when the center of a first Gaussian laser beam is offset from the center of a workpiece by an amount equal to the Gaussian w (radius) value, which in this case is 200 mm. The center of a second Gaussian laser beam is offset by the same amount, but in the opposite direction (−200 mm), from the center of the workpiece. The irradiance of the interfering beams is lower when the beams do not overlap completely. As a result, longer exposure times are required. In addition, in the fringe pattern of 520, the unmodulated light (the “DC” level from the camera pixels) is relatively large, especially near the edges. The modulation levels in the graph are the peak-to-valley variation in the fringes relative to the maximum irradiance at a particular portion of the illuminated workpiece. Because the depth of modulation is 100% for the overlapping beams, the modulation level is constant for this case. Because the depth of modulation is reduced near the edges of the workpiece for the case in the beams are not overlapped, the depth of modulation is reduced for this case. Since the DC level determines the amount of exposure that is possible before overfilling the wells of a photosensitive array, a high depth of modulation is not obtained near the edges of the field of view and accuracy suffers when the beams are not overlapped.

The insights from FIGS. 4 and 5 help explain the benefits of the beam expander 360 in FIG. 3. Suppose that the beam expander is removed from the block diagram of FIG. 3. Consider a case in which the desired diameter of the beams 391, 393 entering the objective lens 370 is 7 mm, with a desired angle of separation of 10.2 mrad. At the beam combiner 385, the required separation between the centers of the beams 385, 389 is then 7 mm. The distance required to bring the beams 385, 389 to the intersection point 392 is 7 mm/10.2 mrad=686 mm, which is much longer than could be used in a portable or bench top scanner.

Herein below a variety of methods are considered for shifting phase, changing fringe pitch, or doing both simultaneously. Devices that perform these functions are referred to as phase/fringe adjusters.

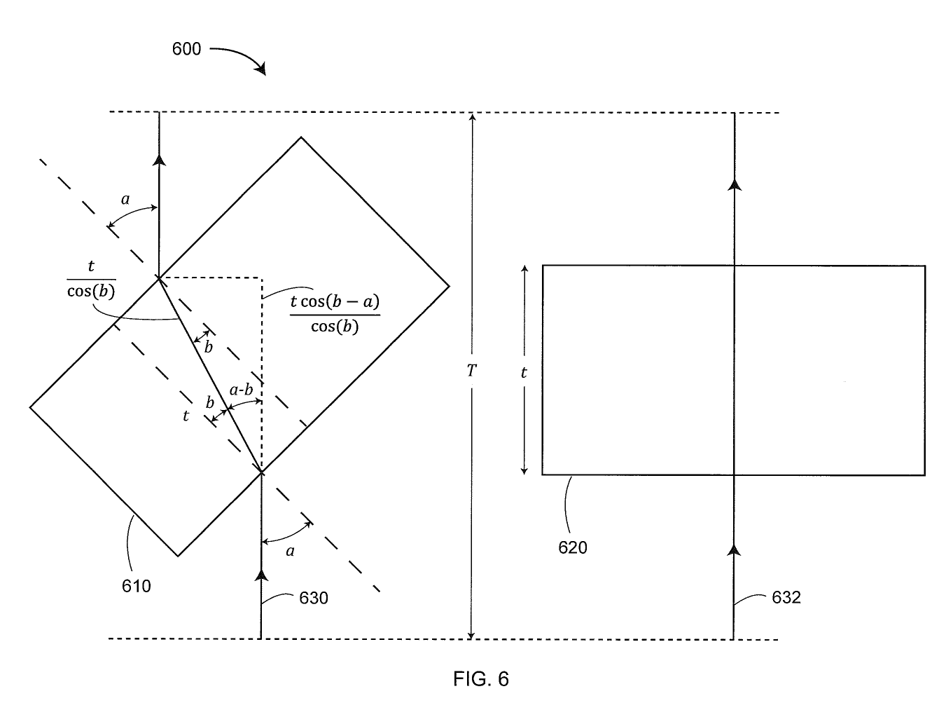

FIG. 6 illustrates a physical principle used to shift the phase of a light beam 630 by rotating a glass window having parallel entrance and exit sides. Representation 600 shows a first window 610 tilted to have an angle of incidence a (with respect to the light beam 630) and a second identical window 620 tilted to have an angle of incidence of zero degrees (with respect to the light beam 632). The result of the rotation of the window 610 is to increase the optical path length (OPL) traveled by the light, this increase corresponding to an increase in the phase of the light. The light that enters the window at an angle of incidence a refracts within the glass to an angle b. The distance traveled by the light in the glass window 610 of thickness t is t/cos(b), and the distance traveled by the light in the glass window 620 is t. For a vertical reference distance T, the distance traveled by the beam 630 in air is T−t cos(b−a)/cos(b). The distance traveled by the beam 632 in air is T−t. For the glass having an index of refraction of n, the total optical path length (OPL) of the beam 630 (including both glass and air paths) is nt/cos(b)+T−t cos(b−a)/cos(b). The total OPL of the untilted glass is nt+T−t. The difference in the total OPL traveled in the tilted glass and the total OPL traveled in the untilted glass is given by

$$\begin{matrix}OPL = \frac{n t}{cos ( b )} + T - \frac{t cos ( b - a )}{cos ( b )} - ( n t + T - t ) \\ = t ( \frac{n}{cos ( b )} - n + 1 - \frac{cos ( b - a )}{cos ( b )} )\end{matrix} \qquad ( 1 )$$

In Eq. (1), the angle b is found using Snell's law, as shown in Eq. (2):

$$b = a sin ( \frac{sin ( a )}{n} ) . \qquad ( 2 )$$

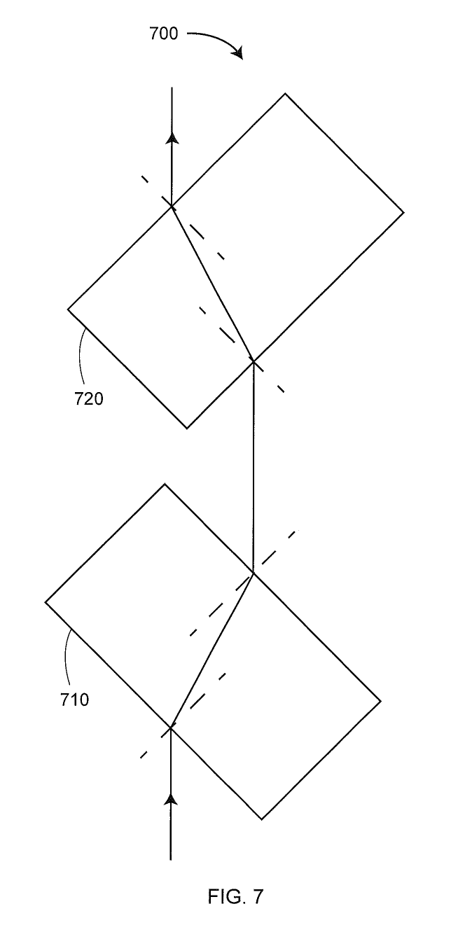

FIG. 7 shows an embodiment in which two windows 710, 720 are tilted at opposite angles so that the emerging beam is not displaced from its original direction. In an embodiment, the light is laser light having a wavelength of 658 nm, and the desired phases are 0, 120, and 240 degrees. The width of the windows is t=100 micrometers and the index of refraction of the window glass is n=1.5. Using Eqs. (1) and (2), it can be shown that the desired phase shifts are obtained when the tilts of the windows 210, 220 in FIG. 2 are set to a=0 degree, a=4.6447 degrees, and a=6.56442 degrees, respectively.

A rotating plate as shown in FIG. 6 or a pair of rotating plates as shown in FIG. 7 may be used to produce a phase shift in one of the two beams 384, 386. It turns out that in most cases, two plates are required, for reasons explained in the remainder of this paragraph. A rotating plate or pair of rotating plates may be placed at positions 340, 342 in FIG. 3 or at positions 280, 282 of FIG. 2. For the case in which a single rotating plate is used, the angle of tilt required to achieve a phase shift of 240 degrees with a glass having an index of refraction of 1.5 and a thickness of 100 micrometers is 9.275 degrees. From FIG. 6, it can be seen that the displacement of the beam of light 630 is given by t sin(a−b)/cos(b). For a rotation angle of 9.275 degrees, the angle b is given by) a sin(sin(9.375°/1.5)=6.23 degrees so that the displacement is equal to 5.5 micrometers. In passing through the beam expander 360 in FIG. 3, the sideways displacement in one of the beams, for example in beam 389 if a rotating plate is located at position 340, is 5.5 micrometers. After passing through the beam expander 360, the sideways displacement is increased by a factor of ten (for an M=10 beam expander) to 55 micrometers. If the objective lens 370 has a focal length of 4.5 mm, then the resulting direction of the beam 391 is changed by an angle of 55 micrometers/4.5 millimeters=0.012 radian. If the distance from the projector 300 and the workpiece is 0.75 meters, the beam 391 that forms one of the two spots 394 will be shifted relative to the other beam of light by an amount of approximately 0.75 m×0.012=9.2 millimeters. It turns out that this shift in positions of the beams causes a reduction in the level of the fringes, as shown in FIG. 5, of 0.85 percent. Since the calculation of distance using the phase shift method described herein above is based on the idea that the fringe levels remain constant but are simply shifted in phase, use of a single rotating wedge in the configuration of FIG. 3 in this case reduces accuracy by a relatively significant amount.

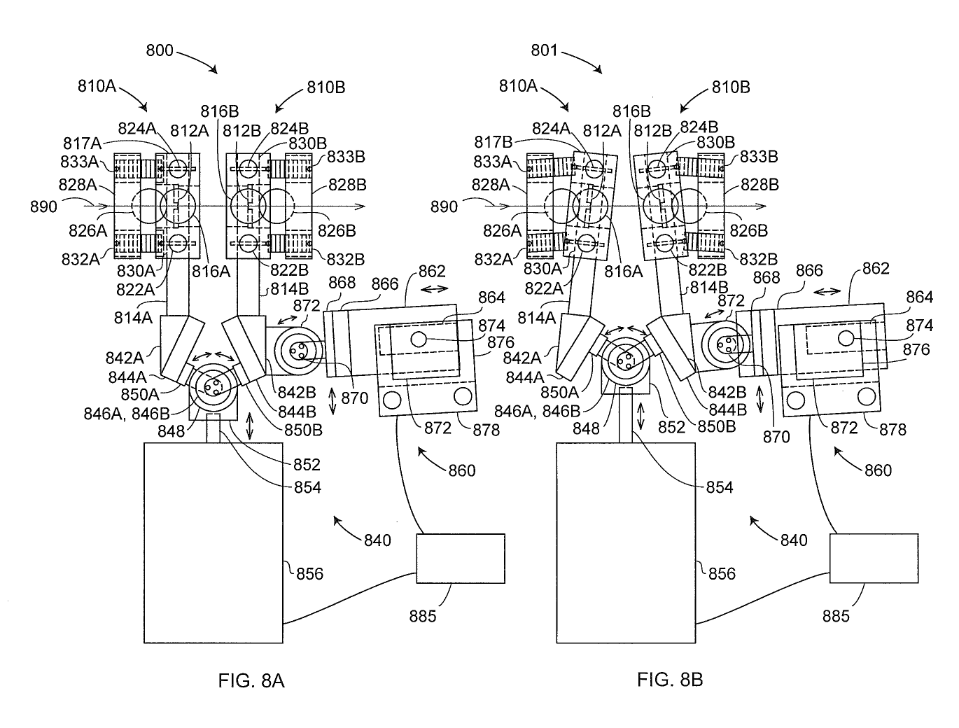

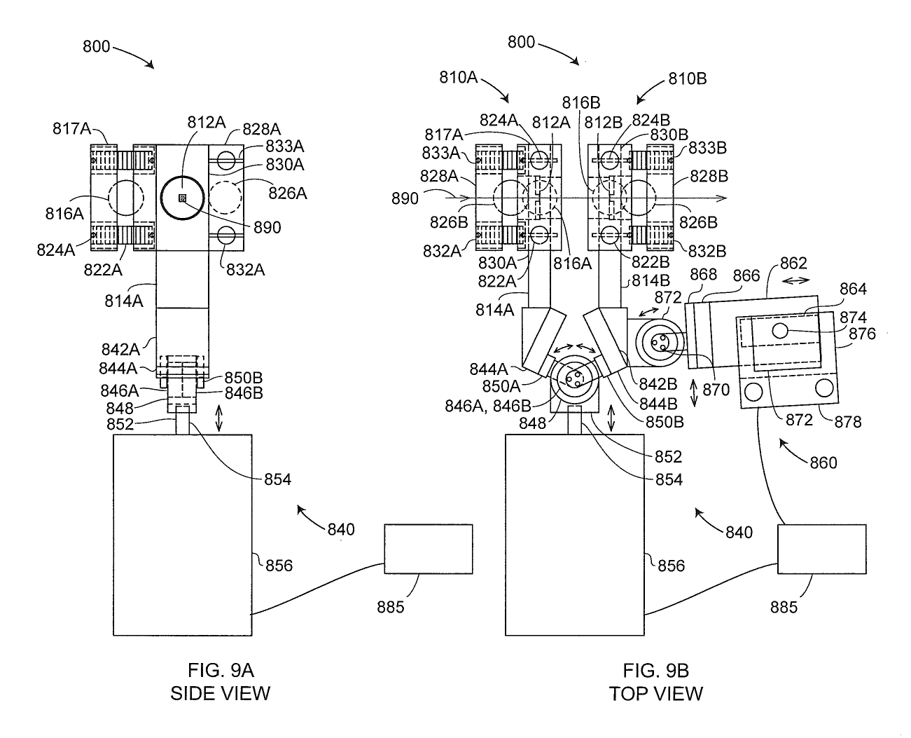

FIGS. 8A, 8B, and 9B show top views and FIG. 9A shows a side view, the views depicting a mechanism that rotates two windows 812A, 812B in opposite directions. The rotating assemblies 810A, 810B that contain the windows 812A, 812B are aligned parallel to one another in FIGS. 8A, 9A, and 9B. The two windows are tilted in opposite directions by approximately 6.6 degrees in FIG. 8B. An actuator assembly 840 converts linear motion into rotary motion, the rotary motion applied in opposite directions to the two rotating assemblies 810A, 810B. A sensor 860 reads the displacement of the assemblies 810A, 810B and provides feedback to the actuator assembly 840, thereby enabling the actuator mechanism 840 to quickly drive the rotating assemblies 810A, 810B to the desired angles.

The rotating assembly 810A includes an extension arm 814A onto which a window 812A is mounted and held in place with a retainer ring. The window 812A is relatively thick over most of its extent but has a small, relatively thin region near the center of the window. For example, the window may be one millimeter over most of its extent but only 100 micrometers thick in a region about 1.5 mm on a side.

In an embodiment, the extension arm and other connected components are supported at three positions: (1) at the base by a ball 816A located directly below the window 812A, (2) on the side by a ball 826A, and (3) on the end by the driver 854 of the actuator 856. The three support positions are designed to allow the window 812A to rotate about its center. The ball 816A is supported by a hardened seat on the base plate 817A and a hardened seat on the extension arm 814A located beneath the window 812A. The ball is held against the hardened seats by two springs 822A, which in turn are held in place by pins 824A.

The ball 826A is held against a side of arm extension 814A, the ball positioned directly to the side of the center of the window 812A. The ball 826A is supported by a hardened seat on the side plate 828A and is pressed against a flat surface in a recess of the extension arm 814A. The ball 826A is held in place by two springs 832A, which in turn are held in place by pins 833A. The elements of rotating assembly 810B are the same as the elements of 810A except that the A suffix is replaced with a B.

The actuator assembly 840 includes an actuator 856, which might be, for example, a voice coil actuator; an actuator driver 854 that moves linearly, a counter-rotating rotary bearing assembly, the rotary bearing assembly including two sealed rotary bearings 846A, 846B; a clamp 848 that holds the two rotary bearings 846A, 846B together as a unit; a base 852 that attaches the clamp 848 to the driver 854; ball slides 844A, 844B that attach to wedge elements 842A, 842B, the wedge elements being attached to an end of the extension arms 814A, 814B, respectively; connecting arms 850A, 850B that connect the ball slides 844A, 844B to the rotary bearings 846A, 846B, respectively.

As the driver 854 applies linear motion to the base 852, the assembly that contains the rotary bearings 846A, 846B moves up or down, thereby causing the ball slides 844A, 844B to move up or down the wedged elements 842A, 842B. At the same time, the separation between the ball slides changes, thereby causing the angle of the ball slides 844A, 844B to change. In response, the rotary bearings 846A, 846B rotate in opposite directions, eliminating the tendency to bind up.

Angle measurement and actuator feedback are provided by a sensor 860. As the wedged element 842B moves to the side, it causes an appendage 870 attached to a rotary bearing 872 and to a ball slide 868 to push a vertical member 866 of translation stage 862. This causes a linear scale 864 mounted on the translation stage to move beneath a stationary read head 872. The read head 872 is attached through a cutout in a mount 876, the mount 876 being screwed to stationary post 878. A hole 874 in the bottom of the read head 872 emits a laser beam that is reflected by the lines of the linear scale 864, the reflected light being read by detectors in the read head 872 and analyzed by a processor in electronics unit 885 to determine the position of the linear scale 864.

The linear encoder does not provide an accurate measure of the angular rotation of the windows 812A, 812B; however it measures linear movements to a repeatability of better than one micrometer, even in a low-cost linear encoder unit. To find the desired positions on the linear encoder to obtain the desired phase shifts a compensation (calibration) procedure is carried out in which the phase shifts are measured by viewing with a camera, such as the camera 140 in FIG. 1, a large pattern of fringes projected onto a flat screen. By measuring the shift over a large collection of fringes, the phase shift as a function of linear position of the linear scale 864 can be determined to high accuracy. Thereafter, the linear encoder provides the actuator, through the intermediary electronics unit 885, with feedback to drive the windows 812A, 812B to the desired angles of tilt.

For an extension arm length of 25 millimeters from the pivot axes that run through the windows 812A, 812B to the corresponding points to which force is applied to the ball slides 844A, 844B, and for an encoder repeatability of 1 micrometer, the phase can be set using the assemblies 800, 801 of FIGS. 8 and 9 to an accuracy of about 0.3 nm, which is a fractional accuracy compared to a wavelength of 658 nm of better than 0.0005.

In the configuration 800 of FIG. 8A, the forces on the pairs of springs 832A, 832B are balanced so that the sum of torque applied by the pairs of springs to the extension arms 814A, 814B is zero. Since the force required on the ball slides 844A, 844B to overcome the torque is approximately equal to the sum of torques applied by the springs divided by the distance from the centers of the windows 812A, 812B to the positions at which the forces are applied to the ball slides 844A, 844B, a relatively small force is required by the actuator 856 to produce the desired rotation. In the configuration 801 of FIG. 8B, the forces on the pairs of springs are not balanced. As can be seen in FIG. 8B, for the springs 832A, 832B, the upper springs are stretched farther than the lower springs so that the forces applied to the extension arms are greater for the upper springs than the lower springs. Consequently, the sum of torques applied by the springs is not near zero, and the actuator 856 will have to apply a larger force.

An alternative that is slightly more complicated but that requires minimal force from the actuator 856 is replace the balls and springs in FIGS. 8 and 9 with axles built into the extension arms 814A, 814B, the axles being positioned directly above the centers of the windows 812A, 812B and with rotary bearings being attached to the axles. In an embodiment having this type of mounting arrangement, the actuator 856 is mounted at 90 degrees to the orientation shown in FIG. 8A, possibly using space more efficiently. In addition, because of the reduced friction, it may be possible to use a smaller actuator 856.

Another possibility is to replace the linear encoder arrangement 860 with a rotary encoder. In an embodiment, the disk from such an encoder is mounted to one of the axle proposed above. Even a relatively inexpensive rotary encoder can obtain a repeatability of 10 microradians or better. By mounting two read heads on a fixed structure, the read heads positioned on opposite sides of the encoder disk, and by averaging the readings of the two read heads, the encoder can be made relatively insensitive to variations in temperature. With this method, high angular performance can be ensured over a large temperature range.

A further extension of the idea of adding two bearing mounted axles is to add a motor to one of the axles. The motor can be a brushless servo motor of the type having permanent magnets mounted directly to the axle and field windings placed on the stationary structure about the permanent magnets. If a coupling arrangement is used that has a functionality similar to that of ball slides 844A, 884B and the rotary bearings 846A, 846B, then a single motor on one of the axles can be used to produce a symmetrical movement in the two windows 812A, 812B. An arrangement that would be somewhat more compact than the assembly 800 of FIGS. 8 and 9 would include two axles, each mounted on two bearings; an angular encoder incorporated into one axle; and a motor incorporated into one axle.

Besides a motor mounted to an axle or a voice coil actuator used in the arrangement of FIGS. 8 and 9, other alternative actuation devices are possible including a ball screw or a cam, for example.

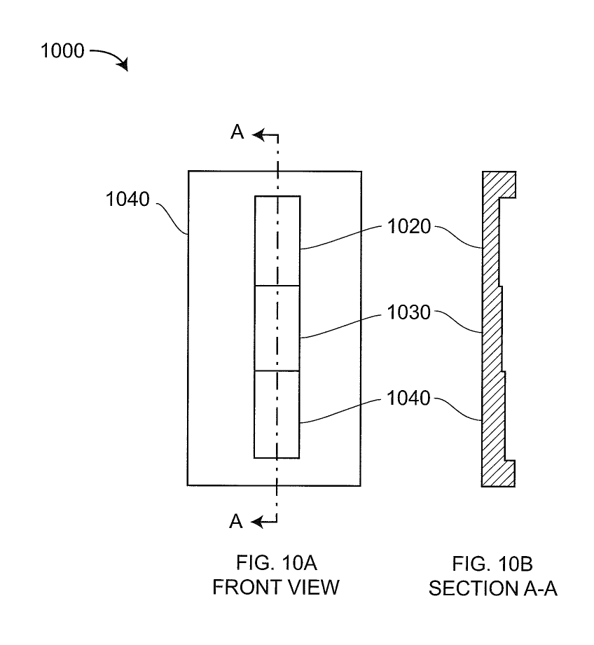

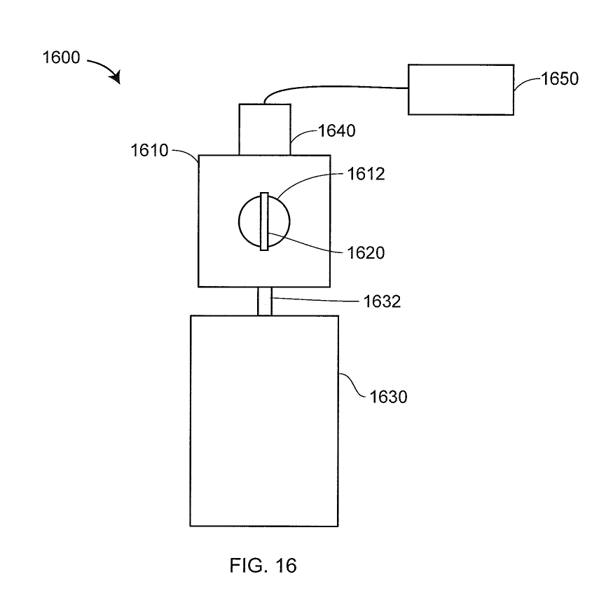

An alternative window element 1000 for shifting phase is shown in FIGS. 10A and 10B. The window element 1000 includes a glass window, possibly of fused silica, into which has been etched three steps 1020, 1030, 1040, the steps each having a different depth. Alternatively, regions may be coated to provide varying thickness rather than being etched to varying depths. In this case, care should be taken keep the transmission through window element 1000 constant for each of the three coatings so that the phase calculation is not compromised. For the window element 1000 oriented perpendicular to an incoming beam of light, the change in OPL between steps is equal to the difference between the step depths times n−1, where n is the index of refraction of the glass. The change in phase in radians is equal to the change in the OPL multiplied by 2π and divided by the wavelength of the light. The window element 1000 may be placed at position 340 or position 342 to obtain the desired phase shifts. The window element may be moved linearly using a mechanism such as that shown in FIG. 16, as discussed in more detail hereinbelow. To obtain three phase shifts, two rather than three steps may be etched into the window element 1000, with the top surface of the window element 1000 used as one of the three surfaces.

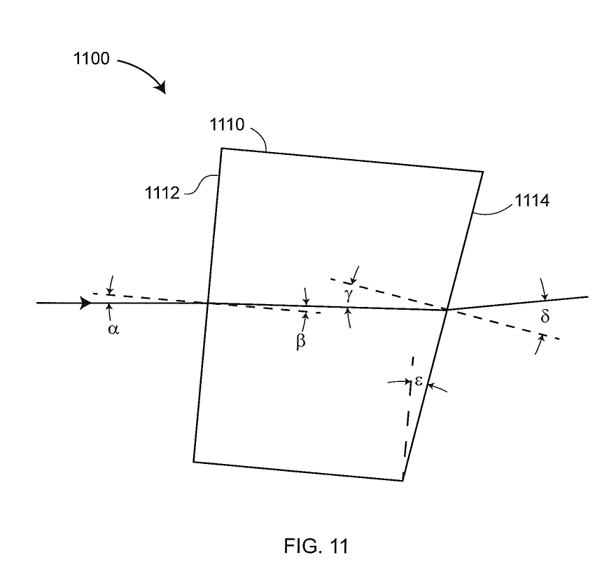

A method for changing fringe pitch is now considered. FIG. 11 shows the geometry of a ray of light traveling through a wedged window 1100 having a wedge angle ε and an angle of incidence α at the first surface 1112. The wedged window 1100 has a first angle of refraction β, a second angle of incidence γ, and a second angle of refraction δ. We are interested in finding the angle of the final ray leaving the wedged window with respect to the initial ray entering the wedged window. In particular, we are interested in how this angular change varies with the angle of incidence α for the case in which α is close to zero.

The change in the beam angle at the first interface is β−α, and the change in the beam angle at the second interface is γ−δ. The second angle of incidence is given by

γ=β+ε (3)

and the total change ζ in beam angle is

ζ=β−α+δ−γ=−α+a sin(n sin(γ))−ε, (4)

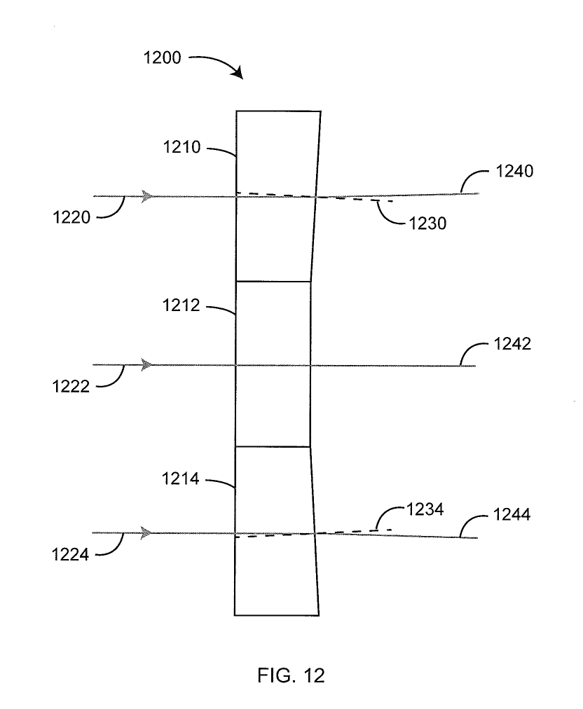

To produce three different angles that give the desired spacings between the spots 394 in FIG. 3, an arrangement of wedged windows can be combined in an assembly 1200 as shown in FIG. 12. The main direction of each beam is set with the mirrors 332, 334. The purpose of the assembly 1200 in FIG. 12 is to make small changes in the angles between the beams 385, 389 in FIG. 3 to produce desired small changes in fringe pitch. This may be done by using in the assembly 1200 an unwedged window 1212 in the center and oppositely angled wedged windows 1210 and 1214 on either side.

As discussed herein above, in an embodiment the desired angles of separation of the light beams entering the objective lens 370 may be aᵢ={10.2, 11.6, 12.9} mrad. If the afocal beam expander 360 has a transverse magnification of ten, the angle of separation between the beams 385 and 389 needs to be ten times larger or approximately {102, 116, 129} mrad, where the angles of separation between beams are ±13.3 mrad. The wedged windows 1210, 1214 can use the same wedged window if the windows are rotated to opposite directions before mounting them on a common assembly.

To produce the desired angles of deviation, the assembly 1200 of FIG. 12 is moved up and down in the plane of the paper. This will produce a consistent angular deviation in each of the three elements 1210, 1212, and 1214, but to maintain there will be a different phase shift in each case, and this phase shift will depend on the position of the assembly 1200 in its up and down movement.

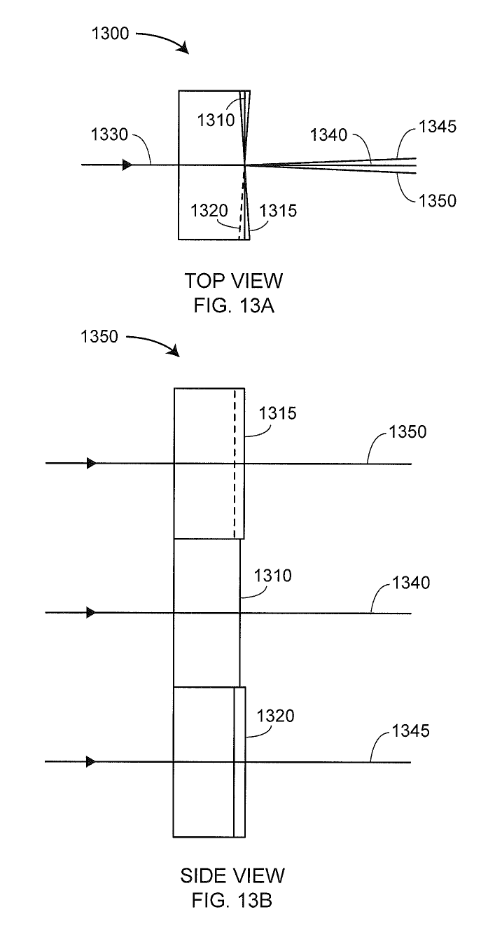

To avoid an undesirable shift in phase with variations in the thickness of the glass as the assembly is moved, the wedges may be arranged as in assembly 1300 of FIGS. 13A and 13B. When seen in the top view of FIG. 13A, the wedge is out of the plane of the paper. A single beam 1330 enters one of the three sections 1310, 1315, 1320. The wedge angle of the glass section 1315, 1311, 1320 will determine the direction of the exiting beams of light 1340, 1350, 1345, respectively. For the beam 1330 entering the unwedged section 1310, the beam 1340 leaves the assembly along the original direction. For the other two sections 1315, 1320, the beam is bent toward the leading edge of the glass, in accordance with FIG. 11. An important aspect of the design of the assembly 1300 (1350) is that the phase of the beam does not change in any one of the sections 1310, 1315, 1320 as the assembly is moved along. This is true as long as the sections 1310, 1315, 1320 are properly aligned so that the glass thickness does not change during movement.

For the case in which the first surfaces of the wedged windows are placed perpendicular to the incoming beams of light 1220, 1222, and 1224, the required wedge angle ε for the wedged windows 1210 and 1214 to obtain an angle of separation of 13.3 mrad is found using Eqs. (3) and (4) to be approximately 26.6 mrad. After passing through the beam expander 360, the angle of separation is reduced by a factor of ten to 1.33 mrad. A question that might be asked is whether wobble in the translation stage that holds the window assembly 1200 will cause a problem. Equations (3) and (4) can be used to answer this question. In a representative ball slide that might be used in the mechanism of FIGS. 13A and 13B, the straightness of the ball slide is 0.00008 m/m. It can be shown for this case that the resulting wobble causes the fringe pitch to vary by less than 0.5 parts per million, which is an acceptable variation.

It is possible to insert the phase shifting assembly of FIGS. 10A and 10B into one arm 340 or 342 of the assembly 300 of FIG. 3 and to insert the fringe shifting assembly 1300 into the other arm 342 or 340. This may simplify the construction of the assemblies 1300, 1000.

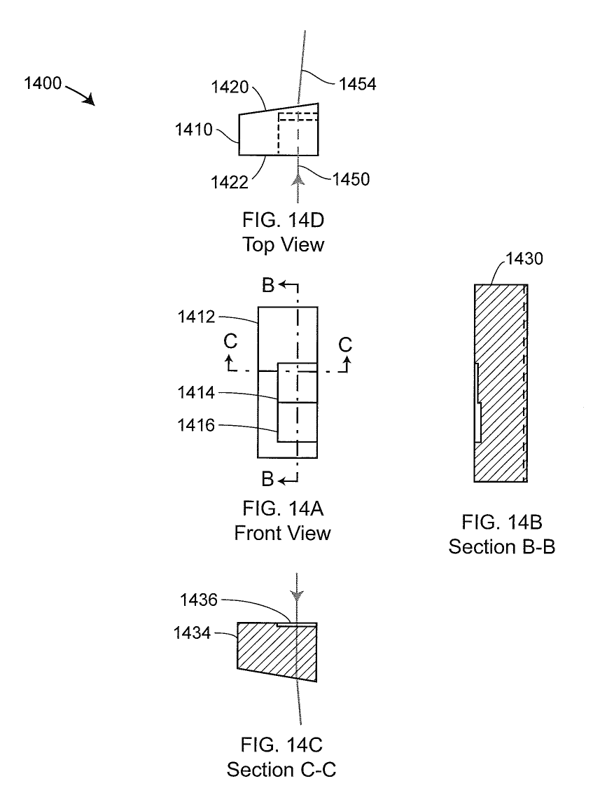

Alternatively, it is possible to perform both a phase shift and a fringe spacing adjustment using a single optical assembly. A single wedged element containing a plurality of steps is shown in FIGS. 14A-D. A wedged window of glass 1410 has an entrance surface 1422 that is not parallel to an exit surface. The top section 1414 of the entrance surface 1422 is unetched. Two sections 1414 and 1416 are etched to different depths. In three other regions 1414, 1416, and 1418, the glass is etched to different depths. A light ray 1450 changes direction as it passes through the angled surface 1420 and exits as ray 1454. The difference in the OPL of a ray 1450 passing through two of the sections 1412, 1414 is equal to the difference in the thickness of the two sections times n−1, where n is the index of refraction of the glass. The phase shift is equal to 2π/λ times the difference in the OPL. As an example, to obtain a phase shift of 120 degrees=2λ/3 radians for a wavelength of 658 nm traveling through a glass having an index of refraction n=1.5, the required difference in the depth of two sections is d=λ/3(n−1)=658/3(1.5−1)=438.7 nm. For a phase shift of 240 degrees, the difference in depths of between two sections would be twice this amount, or 877.3 nm.

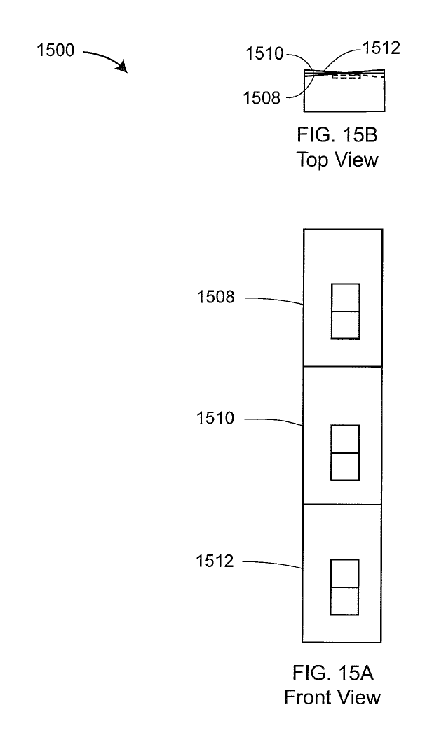

To obtain three different fringe pitches, three different wedge angles are needed. An exemplary embodiment of an optical assembly 1500 having three different wedge angles is shown in front and top views of FIGS. 15A and 15B, respectively. Three windows like that of window 1400 are combined. An easy way to make such an assembly is to use a parallel flat having a wedge angle of zero for window 1510 and using an unetched window having a different angle to begin the fabrication of windows 1508, 1512. The assembly 1500 may be used either at the position 340 or 342 in FIG. 3.

A motorized mechanism 1600 shown in FIG. 16 can be used to provide linear motion to those phase/fringe adjusters that require linear motion, including phase/fringe adjusters 1000, 1200, 1300, and 1500. In an embodiment, the stage 1600 includes a ball slide with a hole at its center. Commercially available ball slides of this type have a specified straightness of 0.00008 m/m. A phase/fringe adjuster is attached to position 1620. Motion is provided by an actuator 1630, which in an embodiment is a voice coil actuator. The actuator 1630 pushes a driver element 1632 to move the ball slide. Position feedback is provided by a sensor 1640, which in an embodiment is a linear encoder. Electronics unit 1650 provides electronics support for the actuator 1630 and feedback sensor 1640. Electronics unit 1650 may contain a processor to provide computational support.

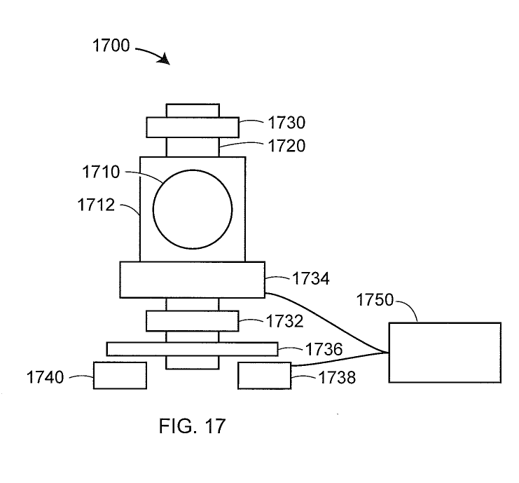

FIG. 17 shows a rotatable mirror 1700, which may be placed at positions 332 or 334 in FIG. 3. The rotatable mirror 1700 may be used as an alternative method of obtaining a change in fringe pitch by changing the angles between the two beams 385, 389 of FIG. 3. It includes a mirror 1710, a mirror mount 1712, an axle 1720 mounted on rotary bearings 1730, 1732, a motor 1734, and an angular encoder that includes a disk scale 1736 and one or more read heads 1738, 1740, and an electronics unit 1750 that provides electronics support for the motors and encoders and a processor for performing computations.

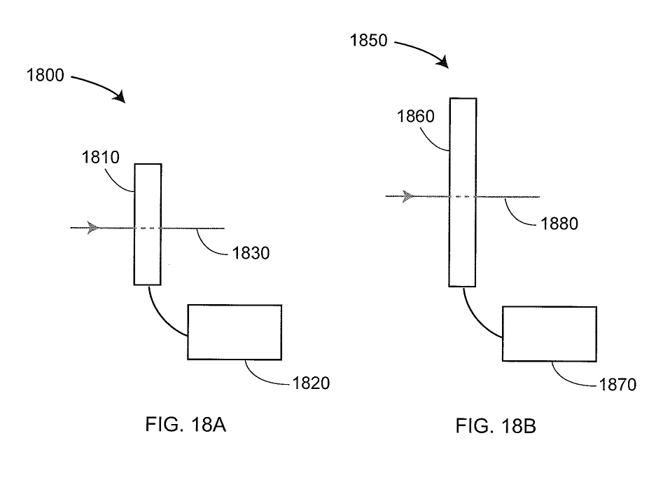

The phase adjuster assembly 1800 of FIG. 18A includes a phase adjuster 1810 that adjusts the phase of light 1830 passing through it and an electronics unit 1820 that provides electronics and processor support. There are a variety of devices that shift the phase of light without requiring mechanical movement. The phase/fringe adjuster assembly 1850 of FIG. 18B is a transmissive spatial light modulator (SLM) that provides a phase shift to light 1880 passing through it by changing the overall index of refraction of the SLM media. It may also provide a fringe adjustment by providing a gradient in the index of refraction, thereby causing a bending of the light. The SLM 1860 includes an electronics unit 1870 that provides electronics and processor support for the SLM. The adjusters 1800 and 1850 may be located at positions 340 or 342 in FIG. 3.

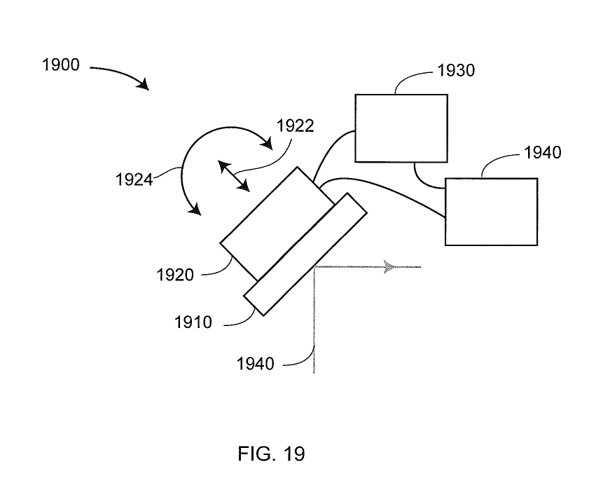

The phase/fringe adjuster assembly 1900 of FIG. 19 includes a mirror 1910 that reflects a light beam 1940 and a piezoelectric (PZT) actuator 1920, a feedback sensor 1930, and an electronics unit 1940. The PZT actuator 1920 may displace the mirror in and out, thereby changing the phase of the light 1940. The PZT actuator 1920 may also rotate the mirror, changing the fringe pitch. The feedback sensor 1930 may be a capacitive sensor, strain gage sensor, or other sensor capable of measuring small motions. The electronics unit 1940 provides processor support and electronics support for the PZT actuator 1920 and feedback sensor 1930. The phase/fringe adjuster assembly 1900 may be attached to the mirror 332 or 334 in FIG. 3.

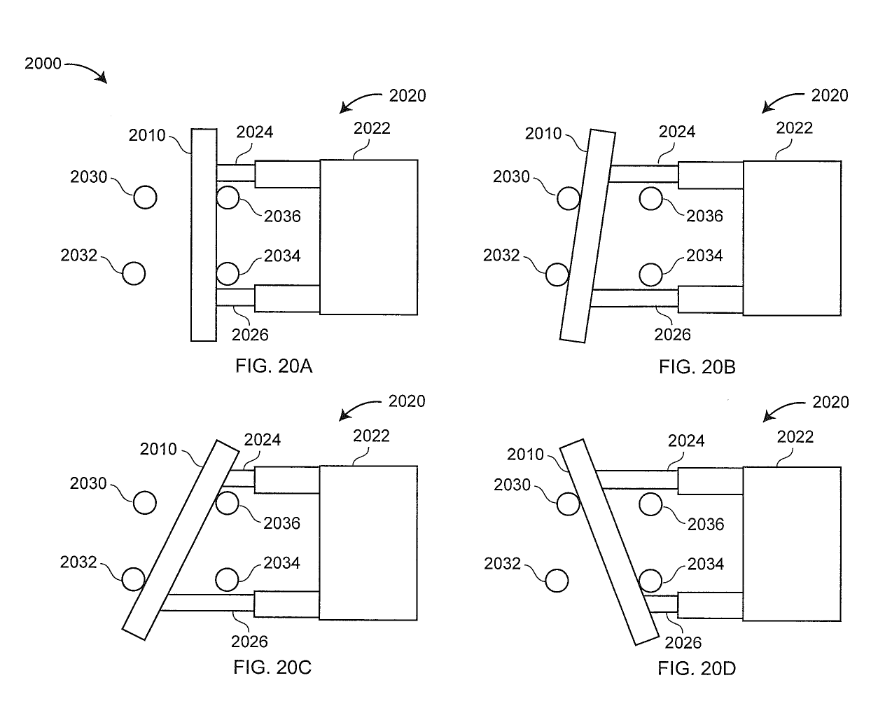

FIG. 20 shows a device 2000 that adjusts fringe pitch by tilting a mirror element 2010 using an actuator 2022 to press the mirror 2010 against hard stops 2030, 2032, 2034, 2036. The advantage of the device depicted in FIG. 20 is that a feedback sensor, often an expensive element, is not required. The actuator may, for example, be an electromagnetic generator attached to the hard stops that cause a ferromagnetic mirror frame to be quickly pulled into position. Alternatively, the actuator may be a piezoelectric actuator or other mechanical device that moves the mirror into position. The fringe adjuster may be used in positions 332, 334 of FIG. 3.

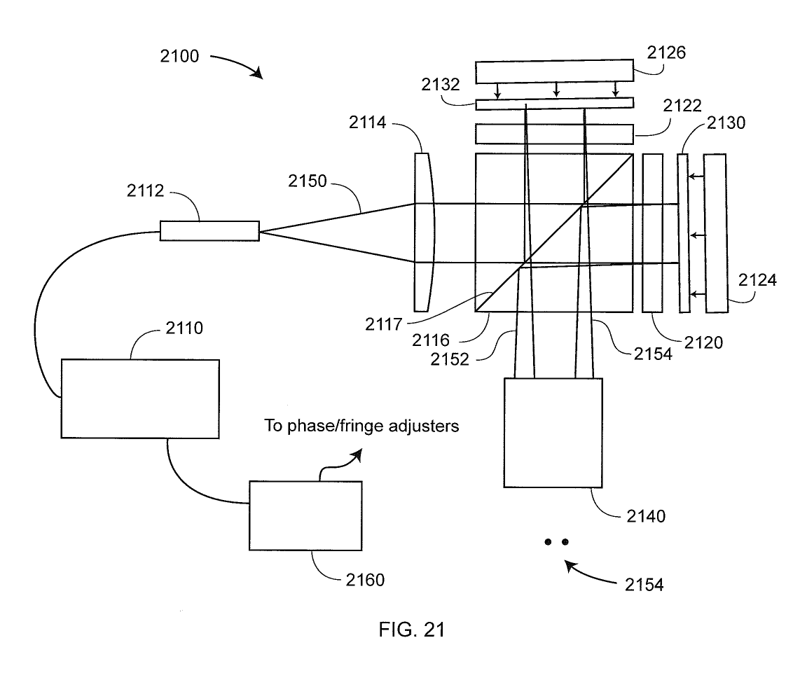

FIG. 21 shows an embodiment of an alternative interferometer assembly 2100 in which a single reflective/transmissive interface 2117 is used instead of a separate beam splitter and beam combiner as in FIG. 3. The assembly 2100 includes a light source 2110, a light launch that includes ferrule 2112 and lens 2114, a beam splitter 2116, mirrors 2130, 2132, optional phase adjusters 2120, 2122, optional mirror phase/fringe adjusters 2124, 2126, objective lens 2140, and an electronics unit 2160 that provides electronics and processor support to the units in the assembly 2100. The laser beams diverge somewhat as they leave the beam splitter 2116. They enter an objective lens where they are focused to two small spots 2154. The optional phase/fringe adjusters 2120, 2122 may be any of assemblies 1000, 1200, 1500, 1800, and 1850. The optional mirror phase/fringe adjusters 2124, 2126 may be any of assemblies 1700, 1900, and 2000.

In some cases, the distance traveled by beams 2152 and 2154 from the interface 2117 to the objective lens 2140 may be relatively large compared to the focal length of the objective lens 2140. In this case, it may be desirable to add a pair of lenses (a beam expander or beam contractor) to cause the beams 2152, 2154 to be transformed to intersect in front of the objective lens 2140 at a distance equal to the focal length of the objective lens 2140.

While the invention has been described with reference to example embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for determining three-dimensional coordinates of a first object point on a surface of an object, the method comprising steps of:
providing a first transparent plate having a first transparent region and a second transparent region, the first region having a first surface, a second surface, a first index of refraction, and a first wedge angle, the first wedge angle being an angle between the first surface and the second surface, the second region having a third surface, a fourth surface, a second index of refraction, and a second wedge angle, the second wedge angle being an angle between the third surface and the fourth surface;
splitting a first beam of light into a first light and a second light, the first light and the second light being mutually coherent;
sending, in a first case, the first light through the first region, the first light passing through the first surface and the second surface, the first region configured to change a direction of the first light by a first deflection angle, the first deflection angle responsive to the first wedge angle and the first index of refraction;
sending, in a second case, the first light through the second region, the first light passing through the third surface and the fourth surface, the second region configured to change a direction of the first light by a second deflection angle, the second deflection angle responsive to the second wedge angle and the second index of refraction, wherein the second deflection angle is different than the first deflection angle;
combining, in the first case, the first light and the second light to produce a first fringe pattern on the surface of the object, the first fringe pattern having a first pitch at the first object point, the first pitch responsive to the first deflection angle;
combining, in the second case, the first light and the second light to produce a second fringe pattern on the surface of the object, the second fringe pattern having a second pitch at the first object point, the second pitch responsive to the second deflection angle, the second pitch different than the first pitch;
imaging, in the first case, the first object point onto a first array point on a photosensitive array to obtain a first electrical data value from the photosensitive array;
imaging, in the second case, the first object point onto the first array point on the photosensitive array to obtain a second electrical data value from the photosensitive array;
determining the three-dimensional coordinates of the first object point based at least in part on the first electrical data value and the second electrical data value; and
storing the three-dimensional coordinates of the first object point.

2. The method of claim 1, further comprising steps of:
providing a second transparent plate, the second transparent plate having a third transparent region and a fourth transparent region, the third region having a fifth surface, a sixth surface, a third index of refraction, a first thickness, and a first optical path length, the fifth surface and the sixth surface being substantially parallel, the first thickness being a distance between the fifth surface and the sixth surface, the first optical path length being the first thickness times the third index of refraction, the fourth region having a seventh surface, an eighth surface, a fourth index of refraction, a second thickness, and a second optical path length, the seventh surface and the eighth surface being substantially parallel, the second thickness being a distance between the seventh surface and the eighth surface, the second optical path length being the second thickness times the fourth index of refraction, wherein the first optical path length and the second optical path length are different;
sending, in the first case, one of either the first light or the second light in a first instance through the third region and in a second instance through the fourth region;
sending, in the second case, the one of either the first light or the second light in a third instance through the third region and in a fourth instance through the fourth region;
imaging the first object point onto the first array point for the first instance to obtain a third electrical data value from the photosensitive array;
imaging the first object point onto the first array point for the second instance to obtain a fourth electrical data value from the photosensitive array;
imaging the first object point onto the first array point for the third instance to obtain a fifth electrical data value from the photosensitive array;
imaging the first object point onto the first array point for the fourth instance to obtain a sixth electrical data value from the photosensitive array; and
in the step of determining the three-dimensional coordinates, the three-dimensional coordinates of the first object point are further based at least in part on the third electrical value, the fourth electrical value, the fifth electrical value, and the sixth electrical value, wherein the first electrical value is equal to the third electrical value and the second electrical value is equal to the fifth electrical value.

3. The method of claim 2, further comprising steps of:
in the step of providing the second transparent plate, further including a fifth region, the fifth region having a ninth surface, a tenth surface, a fifth index of refraction, a third thickness, and a third optical path length, the ninth surface and the tenth surface being substantially parallel, the third thickness being a distance between the ninth surface and the tenth surface, the third optical path length being the third thickness times the fifth index of refraction, wherein the third optical path length is different than the first optical path length and the second optical path length;
sending, in the first case, the one of either the first light or the second light in a fifth instance through the fifth region;
sending, in the second case, the one of either the first light or the second light in a sixth instance through the fifth region;
imaging the first object point onto the first array point for the fifth instance to obtain a seventh electrical value from the photosensitive array;
imaging the first object point onto the first array point for the sixth instance to obtain an eighth electrical value from the photosensitive array; and
in the step of determining the three-dimensional coordinates of the first object point, further including determining the three-dimensional coordinates of the first object point further based on the seventh electrical value and the eighth electrical value.

4. The method of claim 3, further comprising steps of:
calculating a first phase value for the first array point based at least in part on the third electrical signal, the fifth electrical signal, and the seventh electrical signal;
calculating a second phase value for the first array point based at least in part on the fourth electrical signal, the sixth electrical signal, and the eighth electrical signal; and
in the step of determining the three-dimensional coordinates of the first object point, further basing the three-dimensional coordinates of the first object point at least in part on the first phase value and the second phase value.

5. The method of claim 1, further comprising steps of:
providing a first lens system;
sending the combined first light and second light through the first lens system to form a first spot of light and a second spot of light; and
propagating the first spot of light and the second spot of light onto the object.

6. The method of claim 5, further comprising steps of:
providing a second lens system, the second lens system being an afocal lens system having a transverse magnification greater than one; and
sending the combined first light and second light through the second lens system before sending it through the first lens system.

7. The method of claim 1, further comprising steps of:
providing a first beam splitter, the first beam splitter having a first portion configured to reflect light and a second portion configured to transmit light; and
prior to the combining of the first light and the second light, reflecting the first light off the first portion and transmitting the second light through the second portion.

8. The method of claim 1, further comprising steps of:
providing a first beam splitter, the first beam splitter having a first portion configured to reflect light and a second portion configured to transmit light; and
prior to the combining of the first light and the second light, reflecting the second light off the first portion and transmitting the first light through the second portion.

9. The method of claim 1, further comprising steps of:
providing an optical fiber, a collimating lens, and a second beam splitter; and
launching a third light from the optical fiber;
collimating the third light with the collimating lens to form the first beam of light; and
in the step of splitting the first beam of light, further including sending the first beam of light to the second beam splitter to obtain the first light and the second light.

10. The method of claim 1, wherein in the step of splitting a first beam of light, the first beam of light is selected from the group consisting of visible light, infrared light, and ultraviolet light.

11. The method of claim 1, further comprising:
in the step of providing a first transparent plate, further including a step of providing a third transparent region and a fourth transparent region, the first region further having a first thickness and a first optical path length, the second region further having a second thickness and a second optical path length, the third region having a fifth surface, a sixth surface, a third wedge angle, a third index of refraction, a third thickness, and a third optical path length, the fourth region having a seventh surface, an eighth surface, a fourth index of refraction, a fourth wedge angle, a fourth thickness, and a fourth optical path length, the first thickness being a length along a first path between the first surface and the second surface, the first optical path length being the first thickness times the first index of refraction, the second thickness being a length along a second path between the third surface and the fourth surface, the second optical path length being a length along the second thickness times the second index of refraction, the third wedge angle an angle between the fifth surface and the sixth surface, the third thickness being a length along a third path between the fifth surface and the sixth surface, the third optical path length being the third thickness times the third index of refraction, the fourth wedge angle being an angle between the seventh surface and the eighth surface, the fourth thickness being a length along a fourth path between the seventh surface and the eighth surface, the fourth optical path length being the fourth thickness times the fourth index of refraction, wherein the third wedge angle is substantially equal to the first wedge angle, the fourth wedge angle is substantially equal to the second wedge angle, the third optical path length is different than the first optical path length, and the fourth optical path length is different than the second optical path length;
in the step of sending, in the first case, the first light through the first region, further including a step of sending, in a first instance, the first light along the first path;
in the step of sending, in the second case, the first light through the second region, further including a step of sending, in a second instance, the first light along the second path;
sending, in a third instance, the first light along the third path;
sending, in a fourth instance, the first light along the fourth path;
in the step of imaging in the first case the first object point, further including the step of imaging, in the first instance, the first object point on the photosensitive array to obtain the first electrical value;
in the step of imaging in the second case the first object point, further including the step of imaging, in the second instance, the first object point on the photosensitive array to obtain the second electrical value;
imaging, in the third instance, the first object point on the photosensitive array to obtain a third electrical value from the photosensitive array;
imaging, in the fourth instance, the first object point on the photosensitive array to obtain a fourth electrical value from the photosensitive array; and
in the step of determining the three-dimensional coordinates of the first object point, further including the step of determining the three-dimensional coordinates of the first object point based at least in part on the third electrical value and the fourth electrical value.

12. The method of claim 11, further comprising steps of:
in the step of providing the first transparent plate, further including a step of providing a fifth region and a sixth region, the fifth region having a ninth surface, a tenth surface, a fifth wedge angle, a fifth index of refraction, a fifth thickness, and a fifth optical path length, the sixth region having an eleventh surface, a twelfth surface, a sixth wedge angle, a sixth index of refraction, a sixth thickness, and a sixth optical path length, the fifth wedge angle being an angle between the ninth surface and the tenth surface, the fifth thickness being a length along a fifth path between the ninth surface and the tenth surface, the fifth optical path length being the fifth thickness times the fifth index of refraction, the sixth wedge angle being an angle between the eleventh surface and the twelfth surface, the sixth thickness being a length along a sixth path between the eleventh surface and the twelfth surface, the sixth optical path length being the sixth thickness times the sixth index of refraction, wherein the fifth wedge angle is substantially equal to the first wedge angle, the sixth wedge angle is substantially equal to the second wedge angle, the fifth optical path length is different than the first optical path length and the third optical path length, and the sixth optical path length is different than the second optical path length and the fourth optical path length;
sending, in a fifth instance, the first light along the fifth path;
sending, in a sixth instance, the first light along the sixth path;
imaging, in the fifth instance, the first object point on the photosensitive array to obtain a fifth electrical value from the photosensitive array;
imaging, in the sixth instance, the first object point on the photosensitive array to obtain a sixth electrical value from the photosensitive array; and
in the step of determining the three-dimensional coordinates, further determining the three-dimensional coordinates of the first object point based at least in part on the fifth electrical value and the sixth electrical value.

13. The method of claim 12, further comprising steps of:
calculating a first phase value for the first array point based at least in part on the first electrical signal, the third electrical signal, and the fifth electrical signal;
calculating a second phase value for the first array point based at least in part on the second electrical signal, the fourth electrical signal, and the sixth electrical signal; and
in the step of determining the three-dimensional coordinates of the first object point, further basing the three-dimensional coordinates of the first object point at least in part on the first phase value and the second phase value.

14. A method for determining three-dimensional coordinates of a first object point on a surface of an object, the method comprising steps of:
providing a first transparent plate having a first transparent region, a second transparent region, and a third transparent region, the first region having a first surface, a second surface, a first index of refraction, and a first optical path length, the second region having a third surface, a fourth surface, a second index of refraction, and a second optical path length, the third region having a fifth surface, a sixth surface, a third index of refraction, and a third optical path length, the first surface and the second surface being substantially parallel, the first thickness being a distance between the first surface and the second surface, the first optical path length being the first thickness times the first index of refraction, the third surface and the fourth surface being substantially parallel, the second thickness being a distance between the third surface and the fourth surface, the second optical path length being the second thickness times the second index of refraction, the fifth surface and the sixth surface being substantially parallel, the third thickness being a distance between the fifth surface and the sixth surface, the third optical path length being the third thickness times the third index of refraction, wherein the first optical path length, the second optical path length, and the third optical path length are different;
sending a first beam of light to a first beam splitter;
splitting the first beam of light with the first beam splitter into a first light and a second light, the first light and the second light being mutually coherent;
sending, in a first instance, the first light through the first region, the first light passing through the first surface and the second surface;
sending, in a second instance, the first light through the second region, the first light passing through the third surface and the fourth surface;
sending, in a third instance, the first light through the third region, the first light passing through the fifth surface and the sixth surface;
sending the first light and the second light to a beam combiner;
combining the first light and the second light with the beam combiner to form a third light;
sending the third light onto the surface of the object;
imaging, in the first instance, the first object point onto a first array point on a photosensitive array to obtain a first electrical value from the photosensitive array;
imaging, in the second instance, the first object point onto the first array point on the photosensitive array to obtain a second electrical value from the photosensitive array;
imaging, in the third instance, the first object point onto the first array point on the photosensitive array to obtain a third electrical value from the photosensitive array;
determining the three-dimensional coordinates of the first object point based at least in part on the first electrical data value, the second electrical data value, and the third electrical data value; and
storing the three-dimensional coordinates of the first object point.

15. The method of claim 14, further comprising steps of:
providing the beam combiner with a first portion configured to reflect light and a second portion configured to transmit light;
reflecting the first light off the first portion; and
transmitting the second light off the second portion, wherein the reflected first light and the transmitted second light combine to form the third light.

16. The method of claim 14, further comprising steps of:
providing the beam combiner with a first portion configured to reflect light and a second portion configured to transmit light;
reflecting the second light off the first portion; and
transmitting the first light off the second portion, wherein the reflected second light and the transmitted first light combine to form the third light.

17. The method of claim 14, further comprising steps of:
calculating a phase value for the first array point based at least in part on the first electrical signal, the second electrical signal, and the third electrical signal; and
in the step of determining the three-dimensional coordinates of the first object point, further basing the three-dimensional coordinates of the first object point at least in part on the phase value.

18. The method of claim 14, further comprising steps of:
providing a first lens system;
sending the third light through the first lens system to form a first spot of light and a second spot of light; and
propagating the first spot of light and the second spot of light onto the object.

19. The method of claim 14, further comprising steps of:
providing a second lens system, the second lens system being an afocal lens system having a transverse magnification greater than one; and
sending the third light through the second lens system before sending it through the first lens system.

20. The method of claim 14, further comprising steps of:
providing an optical fiber, a collimating lens, and a second beam splitter; and
launching a fourth light from the optical fiber;
collimating the fourth light with the collimating lens to form the first beam of light; and
in the step of splitting the first beam of light, further including sending the first beam of light to the first beam splitter to obtain the first light and the second light.

21. The method of claim 14, wherein in the step of splitting a first beam of light, the first beam of light is selected from the group consisting of visible light, infrared light, and ultraviolet light.

22. A method for determining three-dimensional coordinates of a first object point on a surface of an object, the method comprising steps of:
splitting a first beam of light into a first light and a second light, the first light and the second light being mutually coherent;
providing a first transparent plate assembly including a transparent plate and a rotation mechanism, the first transparent plate having a first surface, a second surface, a first index of refraction, a first thickness, the first surface and the second surface being substantially parallel, the first thickness being a distance between the first surface and the second surface, the rotation mechanism configured to rotate the first transparent plate;
rotating, in a first instance, the first transparent plate to obtain a first angle of incidence of the first surface with respect to the first light;
rotating, in a second instance, the first transparent plate to obtain a second angle of incidence of the first surface with respect to the first light, the second angle of incidence not equal to the first angle of incidence;
rotating, in a third instance, the first transparent plate to obtain a third angle of incidence of the first surface with respect to the first light, the third angle of incidence not equal to the first angle of incidence or the second angle of incidence;
combining the first light and the second light to produce, in the first instance, a first fringe pattern on the surface of the object;
combining the first light and the second light to produce, in the second instance, a second fringe pattern on the surface of the object;
combining the first light and the second light to produce, in the third instance, a third fringe pattern on the surface of the object;
imaging, in the first instance, the first object point onto a first array point on a photosensitive array to obtain a first electrical value from the photosensitive array;
imaging, in the second instance, the first object point onto the first array point to obtain a second electrical value from the photosensitive array;
imaging, in the third instance, the first object point onto the first array point to obtain a third electrical value from the photosensitive array;
determining the three-dimensional coordinates of the first object point based at least in part on the first electrical data value, the second electrical data value, the third electrical data value, the first thickness, the first index of refraction, the first angle of incidence, the second angle of incidence, and the third angle of incidence; and
storing the three-dimensional coordinates of the first object point.

23. The method of claim 22, further comprising steps of:
providing a second transparent plate, the second transparent plate being substantially identical to the first transparent plate;
passing the first beam of light through the first transparent plate and through the second transparent plate to obtain a third light;
rotating the second transparent plate so that the first light and the third light are substantially collinear; and
combining the first light and the second light on the object surface in the first instance, the second instance, and the third instance.
